(19) United States
(12) Patent Application Publication
(10) Pub. No.: US 2018/0106263 A1
(43) Pub. Date: Apr. 19, 2018

(54) SINGLE PIECE BEARING HOUSING WITH TURBINE END PLATE

(71) Applicant: BorgWarner Inc., Auburn Hills, MI (US)

(72) Inventors: Andrew Taylor, Mirfield (GB); Alex Milburn, Holywell Green (GB); Tristram Palmer-White, Bradford (GB)

(21) Appl. No.: 15/293,654

(22) Filed: Oct. 14, 2016

(51) Int. Cl. F04D 29/056; F04D 29/28; F04D 29/053; F04D 25/06; F01D 5/04; F02B 33/40; F02B 37/04

(52) U.S. Cl. CPC F04D 29/056; F04D 29/284; F04D 29/053; F04D 25/06; F05D 2230/60; F02B 33/40; F02B 37/04; F05D 2220/40; F01D 5/04

(57) ABSTRACT

A number of variations may include a product comprising a bearing housing comprising a body having an internal cavity defined by an inner surface of the body, wherein a first end of the body includes an end face and a second end of the body opposite of the end face is open, wherein the end face further comprises a through hole defined by an inner surface of the end face; and an end plate constructed and arranged to attach to the second end of the body of the bearing housing, wherein the end plate further comprise a first face and a second face, and an opening defined by an inner surface of the end plate.

### TECHNICAL FIELD

The field to which the disclosure generally relates to includes turbochargers.

### BACKGROUND

An engine breathing system may include a turbocharger.

### SUMMARY OF ILLUSTRATIVE VARIATIONS

A number of variations may include a product comprising a bearing housing comprising a body having an internal cavity defined by an inner surface of the body, wherein a first end of the body includes an end face and a second end of the body opposite of the end face is open, wherein the end face further comprises a through hole defined by an inner surface of the end face; and an end plate constructed and arranged to attach to the second end of the body of the bearing housing, wherein the end plate further comprise a first face and a second face, and an opening defined by an inner surface of the end plate.

A number of variations may include an electrified turbocharger comprising: a bearing housing comprising a body having a cavity defined by an inner surface of the body, wherein a first end of the body includes an end face and a second end of the body is open; an end plate attached to the second end of the bearing housing; a shaft having a first end and a second end, wherein the first end extends through the end face of the bearing housing and the second end extends through the end plate; an electric motor operatively attached to the shaft; at least one bearing adjacent the electric motor; a compressor wheel attached to the first end of the shaft; and a turbine wheel attached to the second end of the shaft.

A number of variations may include a method of assembling an electrified turbocharger comprising: providing a shaft and wheel assembly which may be pre-balanced; pressing an end plate onto a second end of the shaft; pressing a first bearing onto the shaft adjacent an inboard side of the end plate; pressing a rotor assembly onto the shaft; pressing a second bearing onto the shaft adjacent the rotor assembly; balancing the rotor assembly; providing a bearing housing having an open turbine end; inserting a stator assembly into the bearing housing; inserting the shaft, the second bearing, and the rotor assembly into the bearing housing; axially attaching the end plate to the bearing housing; attaching a compressor wheel to the first end of the shaft; axially clamping the compressor wheel to the shaft; and balancing the full electrified turbocharger assembly.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a schematic of an engine breathing system according to a number of variations.

FIG. 2 illustrates an electrified turbocharger according to a number of variations.

FIG. 3 illustrates a turbocharger end plate assembly according to a number of variations.

FIG. 4 illustrates an electrified turbocharger shaft, turbine wheel, rotor assembly, and bearings according to a number of variations.

FIG. 5 illustrates a flow chart of a method of assembling an electrified turbocharger according to a number of variations.

### DETAILED DESCRIPTION OF ILLUSTRATIVE VARIATIONS

The following description of the variations is merely illustrative in nature and is in no way intended to limit the scope of the invention, its application, or uses.

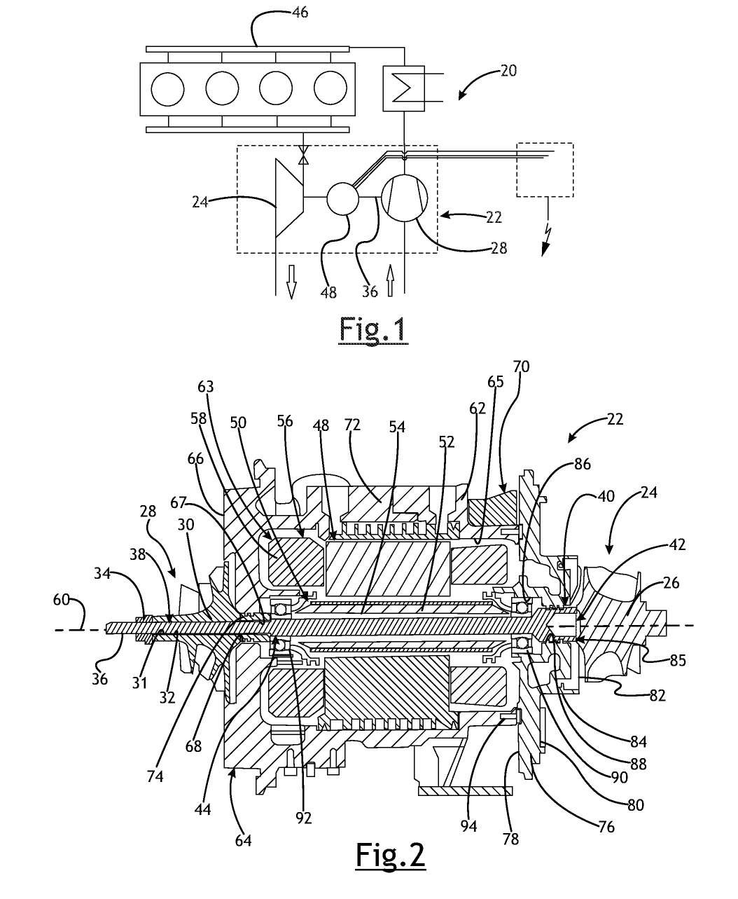

Referring to FIG. 1, in a number of variations, an engine breathing system 20 may include a turbocharger 22 including, but not limited to, an electrified turbocharger. In a number of variations, an electrified turbocharger 22 may include a turbine 24 having a turbine wheel 26 (a variation of which is illustrated in FIG. 2) which may be operatively attached to a compressor 28 having a compressor wheel 30 (a variation of which is illustrated in FIG. 2) via a shaft 36. In a number of variations, the shaft 36 may be supported by one or more bearings 90, 92. The turbine wheel 26 may be driven by exhaust gas fluid-flow which may cause the shaft 36 to rotate which may then drive the compressor wheel 30. The compressor wheel 30 may then pressurize air which may enter the internal combustion engine 46. In a number of variations, an electric motor 48 may be operatively attached to the shaft 36 and may selectively drive the shaft 36.

Referring to FIG. 2, in a number of variations, an electric motor 48 may comprise a rotor assembly 50 which may be driven by a stator assembly 56. The rotor assembly 50 may be coupled to the shaft 36 and may drive the shaft 36. In a number of variations, the stator assembly 56 may operate as an electromagnet which may be energized by field windings 58. The rotor assembly 50 may be rotated by the stator assembly 56 by the interaction between the field windings 58 and magnetic fields in the rotor assembly 50 which may produce a torque about an axis of rotation 60 of the rotor assembly 50. In a number of variations, one or more permanent magnets 52 may be used to provide the magnetic field in the rotor assembly 50. A turbine end bearing 90 and a compressor end bearing 92 may be fit onto the shaft 36 on opposing sides of the rotor assembly 50 respectively and may support the shaft 36.

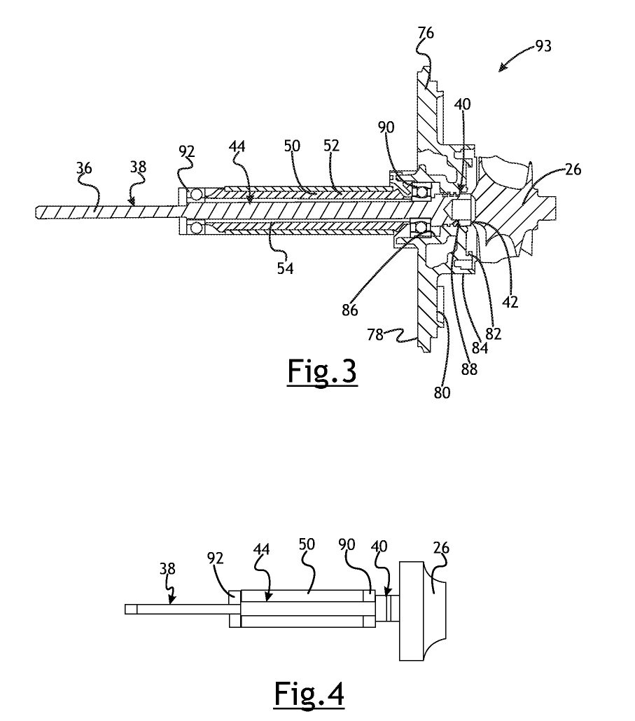

Referring again to FIG. 2, in a number of variations, a bearing housing 62 having an open turbine end 70 may surround at least a portion of the bearings 90, 92, the shaft 36, and the electric motor 48 and may be constructed and arranged to support a first end portion 38 of the shaft 36. A turbine end plate 76 may be attached to the turbine end 70 of the bearing housing 62 and may be constructed and arranged to enclose at least a portion of the turbine end 70 of the bearing housing 62 and may support a second end portion 40 of the shaft 36. The use of a bearing housing 62 having an open turbine end 70 and a turbine end plate 76 may allow for the use of a shaft 36 having an increased thickness at a middle portion 44 of the shaft 36 and/or the addition of a support sleeve 54 which may be press fit onto the middle portion 44 of the shaft 36 to increase the thickness and stiffness of the shaft 36 at the rotor assembly 50 which may improve the natural frequency of the rotor assembly 50. The support sleeve 54 may be a cylindrical tube. The turbine end plate 76, shaft 36, rotor assembly 50, support sleeve 54 (if used), and bearings 90, 92 may form a turbine end plate assembly 93, a variation of which is illustrated in FIG. 3. The use of a bearing housing 62 having an open turbine end 70 and a turbine end plate 76 may also reduce part count, the number of interferences, and tolerance stack up as opposed to a bearing housing having a center split. The use of a bearing housing 62 having an open turbine end 70 and a turbine end plate 76 may also allow for balancing of the turbine end plate assembly 93 prior to or independent of assembly into the bearing housing 62 which may allow for access to the rotor assembly 50 during turbine end plate assembly 93 balancing allowing for material removal without disassembly of the entire turbocharger assembly 22. The bearing housing 62 having an open turbine end 70 and turbine end plate 76 may also allow for easy access to internal components of the turbocharger 22 including, but not limited to, the stator assembly 56.

In a number of variations, the bearing housing 62 may comprise a single continuous component without a center split. The bearing housing 62 include a body 72 having an internal cavity 63 defined by an inner surface 65 of the body 72 constructed and arranged to accommodate at least the electric motor 48, a portion of the shaft 36, the bearings 90, 92, and the slinger assembly 74. The compressor end 64 of the body 72 may include an end face 66 which may include a through hole 67 defined by an inner surface 68 of the end face 66 which may be constructed and arranged to support at least a portion of the compressor wheel 30 and the shaft 36. The turbine end 70 of the body 72 may be open so that the shaft 36, bearings 90, 92, and the electric motor 48 may be axially inserted into the bearing housing 62 through the open turbine end 70. A slinger assembly 74 may be fitted within the bearing housing 62 and may be constructed and arranged to sling oil away from the shaft 36.

Referring again to FIG. 2, in a number of variations, the turbine end plate 76 may be constructed and arranged to be attached to the turbine end 70 of the bearing housing 62. The turbine end plate 76 may include a first face 78, a second face 80 opposite of the first face 78, a third face 82, and a lip 84 which may extend axially between the second face 80 and the third face 82. The term “axial” as used hereafter refers to a direction along or parallel to the axis of rotation 60 of the shaft 36 and the term “radial” used hereafter refers to a direction which extends from or is perpendicular to the axis of rotation 60 of the shaft 36. The turbine end plate 76 may also include an opening 85 defined by a first inner surface 86 and a second inner surface 88 extending through a center of the turbine end plate 76 constructed and arranged to accommodate the second end portion 40 of the shaft 36 and the turbine side bearing 90, as will be discussed hereafter. The first inner surface 86 may include a first diameter and the second inner surface 88 may include a second diameter which may be less than the first diameter.

In a number of variations, the shaft 36 may include a first end portion 38, a second end portion 40, and a third middle portion 44. The first end portion 38 may be at the compressor 28 side, the second end portion 40 may be at the turbine 24 side, and the third middle portion 44 may extend therebetween. The first end portion 38 may have a first diameter and may be constructed and arranged to extend within an opening 31 defined by an inner surface 32 of the compressor wheel 30 and the second end portion 40 may have a second diameter greater than the first diameter constructed and arranged to extend within the through hole 85 in the turbine end plate 76. The end surface 42 of the second end portion 40 of the shaft 36 may be constructed and arranged to allow for axial attachment of the turbine wheel 26. The third middle portion 44 may have a third diameter which may be greater than the first diameter but less than the second diameter and may be constructed and arranged to accommodate the compressor bearing 92, the turbine bearing 90, and the rotor assembly 50 and/or the support sleeve 54.

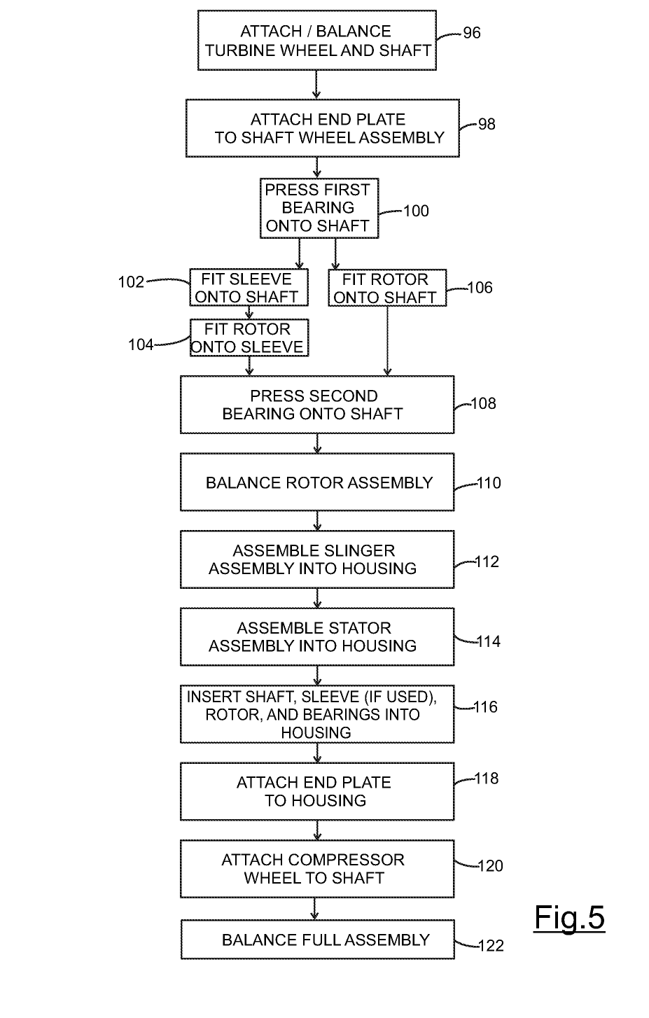

Referring to FIG. 5, in a number of variations, a turbocharger 22 may be assembled including a first step 96 comprising axially attaching the turbine wheel 26 to the shaft 36. The turbine wheel 26 may be attached to the shaft 36 in any number of variations including, but not limited to, friction welding. The shaft 36 and the wheel 26 assembly may then be balanced as a single component. Attaching the turbine wheel 26 at the first step 96 is described above for illustrative purposes only and it is noted that the turbine wheel 26 may be attached to the shaft 36 at any point in assembly of the turbocharger 22.

A second step of assembly 98 may include axially fitting the second inner surface 88 of the turbine end plate 76 onto the second end portion 40 of the shaft 36 so that the first face 78 of the turbine end plate 76 faces inboard.

A third step 100 of assembly of the turbocharger 22 may comprise axially pressing the turbine end bearing 90 onto the third middle portion 44 of the shaft 36 so that it is positioned within the first inner surface 86 of the turbine end plate 76.

A fourth step 102 of assembly may include fitting a support sleeve 54 onto the shaft 36 to form a compound shaft to increase the stiffness of the shaft 36 at the rotor assembly 50. A fifth step 104 of assembly may include pressing the rotor assembly 50 axially onto the support sleeve 54 on the shaft 36. In another variation, a support sleeve 54 may not be used so that the third step 100 may be directly followed by a sixth step 106 where the rotor assembly 50 may be axially pressed onto the third middle portion 44 of the shaft 36.

A seventh step 108 of assembly may include axially pressing the compressor end bearing 92 onto the third middle portion 44 of the shaft 36 against the rotor assembly 50, and/or the sleeve 54. The turbine end plate 76, shaft 36, rotor assembly 50, support sleeve 54 (if used), turbine end bearing 90, and compressor end bearing 92 may form the turbine end plate assembly 93, a variation of which is illustrated in FIG. 3. In a number of variations, the outer diameters of the rotor assembly 50, the turbine end bearing 90, and the compressor end bearing 92 may be the same to form a uniform cartridge, a variation of which is illustrated in FIG. 4.

An eighth step 110 of assembly may comprise testing the rotating balance of the rotor assembly 50. During the rotating balance test, the balance of the rotor assembly 50 may be adjusted by radially cutting a portion of the rotor assembly 50.

A ninth step 112 of assembly may comprise fitting a slinger assembly 74 into the bearing housing 62 through the open turbine end 70 of the bearing housing 62.

A tenth step 114 of assembly may comprise assembling a stator assembly 56 into the body 72 of the bearing housing 62 through the open turbine end 70 of the bearing housing 62.

An eleventh step 116 of assembly may include axially inserting the turbine end plate assembly 93 into the turbine end 70 of the bearing housing 62 so that a portion of the first face 78 of the turbine end plate 76 may be pressed against the turbine end 70 of the bearing housing 62.

A twelfth step 118 of assembly may comprise fixing the turbine end plate 76 to the turbine end 70 of the bearing housing 62 using one or more mechanical fasteners 94 including, but not limited to, a bolt and/or a v band.

A thirteenth step 120 of assembly may comprise attaching the inner surface 32 of the compressor wheel 30 to the first end portion 38 of the shaft 36 and axially clamping the compressor wheel 30 to the shaft 36 with a compressor nut 34.

A fourteenth step 122 of assembly may comprise testing/balancing of the full turbocharger assembly 22. During the rotating balance test, material may be added or removed from the shaft 36 to balance the turbocharger assembly 22.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: a bearing housing comprising a body having an internal cavity defined by an inner surface of the body, wherein a first end of the body includes an end face and a second end of the body opposite of the end face is open, wherein the end face further comprises a through hole defined by an inner surface of the end face; and an end plate constructed and arranged to attach to the second end of the body of the bearing housing, wherein the end plate further comprise a first face and a second face, and an opening defined by an inner surface of the end plate.

Variation 2 may include a product as set forth in Variation 1 further comprising a shaft, wherein a first end of the shaft extends through the through hole in the end face of the body of the bearing housing and a second end of the shaft extends through the opening in the end plate; a compressor wheel operatively attached to the first end of the shaft; a turbine wheel operatively attached to the second end of the shaft; an electric motor operatively attached to the shaft; and at least one bearing adjacent the electric motor.

Variation 3 may include a product as set forth in Variation 2 wherein the bearing housing and the end plate are attached together via at least one mechanical fastener.

Variation 4 may include a product as set forth in any of Variations 2-3 further comprising a slinger assembly operatively attached to the bearing housing.

Variation 5 may include a product as set forth in any of Variations 2-4 wherein the electric motor comprises a rotor assembly operatively attached to a middle portion of the shaft and a stator assembly which surrounds the rotor assembly.

Variation 6 may include a product as set forth in any of Variations 1-5 wherein the end plate further comprise a third face, and wherein a lip extends between the second face and the third face.

Variation 7 may include an electrified turbocharger comprising: a bearing housing comprising a body having a cavity defined by an inner surface of the body, wherein a first end of the body includes an end face and a second end of the body is open; an end plate attached to the second end of the bearing housing; a shaft having a first end and a second end, wherein the first end extends through the end face of the bearing housing and the second end extends through the end plate; an electric motor operatively attached to the shaft; at least one bearing adjacent the electric motor; a compressor wheel attached to the first end of the shaft; and a turbine wheel attached to the second end of the shaft.

Variation 8 may include an electrified turbocharger as set forth in Variation 7 further comprising a slinger assembly operatively attached to the bearing housing.

Variation 9 may include an electrified turbocharger as set forth in in any of Variations 7-8 wherein the end plate is attached to the bearing housing via one or more mechanical fasteners.

Variation 10 may include an electrified turbocharger as set forth in any of Variations 7-9 wherein the electric motor comprises a rotor assembly operatively attached to a middle portion of the shaft and a stator which surrounds the rotor assembly.

Variation 11 may include a method of assembling an electrified turbocharger comprising: providing a shaft having a first end and a second end; attaching a turbine wheel to the second end of the shaft; pressing an end plate onto the second end of the shaft; pressing a first bearing onto the shaft adjacent an inboard side of the end plate; pressing a rotor assembly onto the shaft; pressing a second bearing onto the shaft adjacent the rotor assembly; providing a bearing housing having an open turbine end; inserting a stator assembly into the bearing housing; inserting the shaft, the second bearing, and the rotor assembly into the bearing housing; axially attaching the end plate to the bearing housing; attaching a compressor wheel to the first end of the shaft; and axially clamping the compressor wheel to the shaft.

Variation 12 may include a method as set forth in Variation 11 further comprising pressing a sleeve onto the shaft after pressing the first bearing onto the shaft and prior to pressing the rotor assembly onto the shaft.

Variation 13 may include a method as set forth in any of variations 11-12 further comprising balancing the shaft and the turbine wheel prior to pressing the end plate onto the second end of the shaft.

Variation 14 may include a method as set forth in any of Variations 11-13 further comprising balancing the rotor assembly on the shaft prior to inserting the shaft, the second bearing assembly, and the rotor assembly into the bearing housing.

Variation 15 may include a method as set forth in any of Variations 11-14 further comprising balancing the electrified turbocharger after axially clamping the compressor wheel to the shaft.

Variation 16 may include a method as set forth in any of Variations 11-15 further comprising inserting a slinger assembly into the bearing housing prior to inserting the stator assembly into the bearing housing.

Variation 17 may include a method as set forth in any of Variations 11-16 wherein the end plate is axially attached to the bearing housing using one or more mechanical fasteners.

The above description of select variations within the scope of the invention is merely illustrative in nature and, thus, variations or variants thereof are not to be regarded as a departure from the spirit and scope of the invention.

What is claimed is:

1. A product comprising:
a bearing housing comprising a body having an internal cavity defined by an inner surface of the body, wherein a first end of the body includes an end face and a second end of the body opposite of the end face is open, wherein the end face further comprises a through hole defined by an inner surface of the end face; and
an end plate constructed and arranged to attach to the second end of the body of the bearing housing, wherein the end plate further comprise a first face and a second face, and an opening defined by an inner surface of the end plate.

2. The product of claim 1 further comprising a shaft, wherein a first end of the shaft extends through the through hole in the end face of the body of the bearing housing and a second end of the shaft extends through the opening in the end plate; a compressor wheel operatively attached to the first end of the shaft; a turbine wheel operatively attached to the second end of the shaft; an electric motor operatively attached to the shaft; and at least one bearing adjacent the electric motor.

3. The product of claim 2 wherein the bearing housing and the end plate are attached together via at least one mechanical fastener.

4. The product of claim 2 further comprising a slinger assembly operatively attached to the bearing housing.

5. The product of claim 2 wherein the electric motor comprises a rotor assembly operatively attached to a middle portion of the shaft and a stator assembly which surrounds the rotor assembly.

6. The product of claim 1 wherein the end plate further comprise a third face, and wherein a lip extends between the second face and the third face.

7. An electrified turbocharger comprising:
a bearing housing comprising a body having a cavity defined by an inner surface of the body, wherein a first end of the body includes an end face and a second end of the body is open;
an end plate attached to the second end of the bearing housing;
a shaft having a first end and a second end, wherein the first end extends through the end face of the bearing housing and the second end extends through the end plate;
an electric motor operatively attached to the shaft;
at least one bearing adjacent the electric motor;
a compressor wheel attached to the first end of the shaft; and
a turbine wheel attached to the second end of the shaft.

8. The electrified turbocharger of claim 7 further comprising a slinger assembly operatively attached to the bearing housing.

9. The electrified turbocharger of claim 7 wherein the end plate is attached to the bearing housing via one or more mechanical fasteners.

10. The electrified turbocharger of claim 7 wherein the electric motor comprises a rotor assembly operatively attached to a middle portion of the shaft and a stator which surrounds the rotor assembly.

11. A method of assembling an electrified turbocharger comprising:
providing a shaft having a first end and a second end;
attaching a turbine wheel to the second end of the shaft;
pressing an end plate onto the second end of the shaft;
pressing a first bearing onto the shaft adjacent an inboard side of the end plate;
pressing a rotor assembly onto the shaft;
pressing a second bearing onto the shaft adjacent the rotor assembly;
providing a bearing housing having an open turbine end;
inserting a stator assembly into the bearing housing;
inserting the shaft, the second bearing, and the rotor assembly into the bearing housing;
axially attaching the end plate to the bearing housing;
attaching a compressor wheel to the first end of the shaft; and
axially clamping the compressor wheel to the shaft.

12. The method of claim 10 further comprising pressing a sleeve onto the shaft after pressing the first bearing onto the shaft and prior to pressing the rotor assembly onto the shaft.

13. The method of claim 11 further comprising balancing the shaft and the turbine wheel prior to pressing the end plate onto the second end of the shaft.

14. The method of claim 11 further comprising balancing the rotor assembly on the shaft prior to inserting the shaft, the second bearing assembly, and the rotor assembly into the bearing housing.

15. The method of claim 11 further comprising balancing the electrified turbocharger after axially clamping the compressor wheel to the shaft.

16. The method of claim 11 further comprising inserting a slinger assembly into the bearing housing prior to inserting the stator assembly into the bearing housing.

17. The method of claim 11 wherein the end plate is axially attached to the bearing housing using one or more mechanical fasteners.
